(19) United States
(12) Patent Application Publication
(10) Pub. No.: US 2013/0066444 A1
(43) Pub. Date: Mar. 14, 2013

(54) SYSTEMS AND METHODS FOR USE IN RESPONDING TO FAULTS IN A UTILITY SYSTEM

(71) Applicants: Bogdan Cristian Popescu, Calgary (CA); Jiyuan Fan, Duluth, GA (US); Daryl Cowie, Calgary (CA); Willem Hendrik Du Toit, Cochrane (CA)

(72) Inventors: Bogdan Cristian Popescu, Calgary (CA); Jiyuan Fan, Duluth, GA (US); Daryl Cowie, Calgary (CA); Willem Hendrik Du Toit, Cochrane (CA)

(21) Appl. No.: 13/229,951

(22) Filed: Sep. 12, 2011

(51) Int. Cl. G05B 9/02

(52) U.S. Cl. 700/19

(57) ABSTRACT

Systems and methods for use in detecting and responding to fault conditions in a utility system. A first partition controller associated with a first partition detects a fault condition within the first partition. The first partition controller transmits a utility capacity request to one or more partition controllers other than the first partition controller. A second partition controller associated with a second partition receives the utility capacity request and determines an available utility capacity of the second partition. The second partition controller transmits a utility capacity response that includes the available utility capacity to the first partition controller. A utility connection is activated between the first partition and the second partition based on the available utility capacity.

### BACKGROUND OF THE INVENTION

The subject matter disclosed herein relates generally to utility systems and, more specifically, to systems and methods for use in automatically responding to faults in a utility system.

At least some known utility systems are used to convey a utility, such as electricity, from one or more sources to one or more demand points or sites. Further, utility equipment may be grouped into partitions, which may include one or more substations and associated service regions in a distribution grid, for example. In some cases, utility equipment in a partition may malfunction, creating a fault condition. Such a fault condition may cause a service interruption associated with a decrease in utility output at the partition.

Utility output at the partition may be temporarily restored by activating a utility connection between the partition and a neighboring partition with excess available capacity. Conveying the utility over this connection may fully or partially compensate for the decrease in utility output. Further, after the equipment malfunction is corrected, the utility connection may be deactivated, and the partition may produce the normal utility output without assistance from the neighboring partition. However, such known utility systems require manual intervention by a human operator to determine what neighboring partitions may have available capacity, activate a utility connection to a neighboring partition, and deactivate the utility connection. Such manual operator involvement may delay the process of responding to a fault condition, introduce a risk of operator error, and/or increase operating costs.

### BRIEF DESCRIPTION OF THE INVENTION

In one aspect, a system for use in operating a utility system that provides a utility is provided. The system includes an equipment control interface, a processor coupled to the equipment control interface, and a communication interface that is coupled to the processor. The equipment control interface is configured to detect a fault condition at a first partition of the utility system. The processor is programmed to determine a desired amount of the utility based on a decrease in utility output associated with the fault condition, and to determine a plurality of partitions other than the first partition that are capable of conveying the utility to the first partition. The communication interface is configured to transmit a utility capacity request to a plurality of remote partition controllers. Each remote partition controller is associated with a partition of the plurality of partitions, and the utility capacity request indicates the desired amount of the utility.

In another aspect, a method for use in operating a utility system that includes a first partition and a second partition is provided. The method includes detecting, by a first partition controller associated with the first partition, a fault condition within the first partition. A utility capacity request is transmitted by the first partition controller to one or more partition controllers other than the first partition controller. The utility capacity request is received by a second partition controller associated with the second partition. An available utility capacity of the second partition is determined by the second partition controller. A utility capacity response that includes the available utility capacity of the second partition is transmitted by the second partition controller to the first partition controller. A utility connection is activated between the first partition and the second partition based on the available utility capacity.

In yet another aspect, one or more computer-readable storage media having computer-executable instructions embodied thereon are provided. When executed by at least one processor, the computer-executable instructions cause the at least one processor to detect a fault condition associated with a decrease in utility output at a first partition of a utility system, to determine a desired amount of the utility based on the decrease in utility output, to receive an available utility capacity from a partition controller that is associated with a second partition of the utility system, and to activate a utility connection between the first partition and the second partition based on the available utility capacity.

### BRIEF DESCRIPTION OF THE DRAWINGS

FIG. 1 is a block diagram of an exemplary computing device that may be used to monitor and/or operate utility equipment in a utility system;

FIG. 2 is block diagram of an exemplary utility system that includes a first partition, a second partition, and a third partition;

FIG. 3 is a flowchart of an exemplary method that may be used in requesting and receiving assistance from another partition that may be used with the utility system shown in FIG. 2; and

FIG. 4 is a flowchart of an exemplary method that may be used in responding to a request for assistance from another partition that may be used with the utility system shown in FIG. 2.

### DETAILED DESCRIPTION OF THE INVENTION

The embodiments described herein facilitate automatically responding to fault conditions in a utility system that includes a plurality of partitions. In exemplary embodiments, a partition controller monitors utility equipment within a partition and, in response to a fault condition associated with decreased utility output, requests assistance from one or more other partition controllers that are associated with another partition. Each partition controller determines and reports the available utility capacity of a corresponding partition, such that utility service at the requesting partition may be restored by automatically activating a utility connection between the requesting partition and an assisting partition.

As used herein, the term “fault condition” refers to a utility equipment malfunction and/or a utility service interruption. A utility includes, for example, electricity service.

A utility is conveyed utility from one or more sources to one or more demand points or sites by a utility system, also referred to as a utility network or a utility grid. For example, a source may include a utility generation facility and/or a specific point along a utility transmission line. A site may include, but is not limited to only including, a utility distribution facility (e.g., a substation and/or a transformer), a residential property, a commercial property, and/or an industrial property.

The means of conveying a utility may be dependent on the nature of the utility. For example, electricity may be conveyed via electrically conductive cables, whereas natural gas and potable water are generally conveyed via a piping network. Telecommunication service may be conveyed by electrically conductive cables, optical cables, and/or wireless transmission.

Embodiments are described herein with reference to utility systems for electricity. However, such embodiments are applicable to any type of utility service.

An exemplary technical effect of the methods, systems, and apparatus described herein includes at least one of (a) determining, by a first partition controller associated with a first partition, a fault condition within the first partition; (b) transmitting, by the first partition controller, a utility capacity request to one or more partition controllers other than the first partition controller; (c) receiving, by a second partition controller associated with the second partition, the utility capacity request; (d) determining, by the second partition controller, an available utility capacity of a second partition; (e) transmitting, by the second partition controller, a utility capacity response that includes the available utility capacity of the second partition to the first partition controller; (f) activating a utility connection between the first partition and the second partition based on the available utility capacity; (g) detecting a resolution of the fault condition; and (h) in response to the resolution, closing the utility connection between the first partition and the second partition.

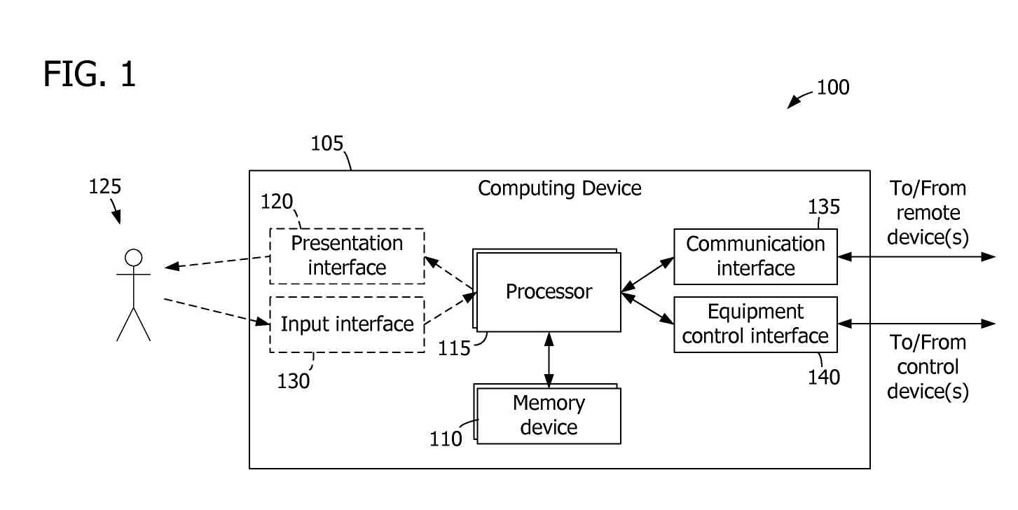

FIG. 1 is a block diagram of an exemplary system 100 with a computing device 105 that includes a memory device 110 and that may be used to monitor and/or control utility equipment. Computing device 105 includes a processor 115 coupled to memory device 110 for executing programmed instructions. In some embodiments, executable instructions are stored in memory device 110. Computing device 105 is programmable to perform one or more operations described herein by programming processor 115. For example, processor 115 may be programmed by encoding an operation as one or more executable instructions and providing the executable instructions in memory device 110. Processor 115 may include one or more processing units (e.g., in a multi-core configuration).

Processor 115 may include, but is not limited to, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a non-transitory computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

Memory device 110 is one or more devices allowing information such as executable instructions and/or other data to be stored and retrieved. Memory device 110 may include one or more computer readable media, such as, without limitation, dynamic random access memory (DRAM), static random access memory (SRAM), a solid state disk, and/or a hard disk. Memory device 110 may be configured to store, without limitation, executable instructions and/or any other type of data suitable for use with the methods described herein.

In the exemplary embodiment, computing device 105 includes a presentation interface 120 coupled to processor 115. Presentation interface 120 is configured to output (e.g., display, print, and/or otherwise output) information, such as, but not limited to, utility equipment information, available utility capacities, desired amounts of a utility, and/or fault conditions, to a user 125. For example, presentation interface 120 may include a display adapter (not shown in FIG. 1) that is coupled to a display device, such as a cathode ray tube (CRT), a liquid crystal display (LCD), an organic LED (OLED) display, and/or an “electronic ink” display. In some embodiments, presentation interface 120 includes more than one display device. In addition to, or in the alternative, presentation interface 120 may include a printer.

In some embodiments, computing device 105 includes an input interface 130 that receives input from user 125. For example, input interface 130 may be configured to receive a selection of a geographic area, a selection or entry of configuration data (e.g., a maximum interruption occurrence rate), and/or any other information suitable for use with the methods and systems described herein.

In the exemplary embodiment, input interface 130 is coupled to processor 115 and may include, for example, a keyboard, a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of presentation interface 120 and as input interface 130.

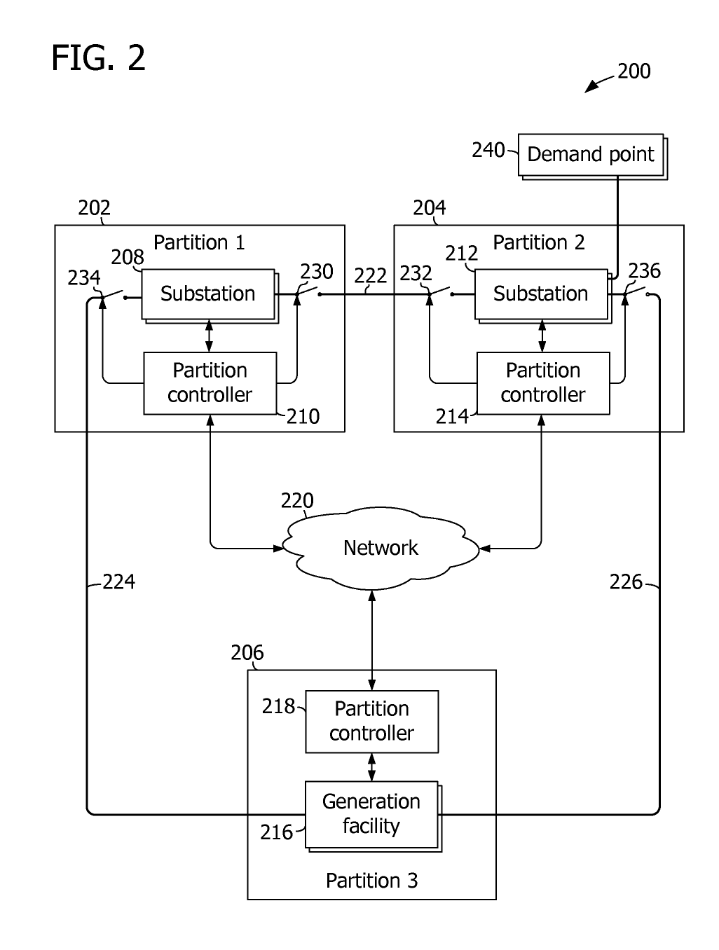

In exemplary embodiments, computing device 105 includes a communication interface 135 and an equipment control interface 140 that are coupled to processor 115. Communication interface 135 is coupled in communication with a remote device, such as another computing device 105. For example, communication interface 135 may include, without limitation, a wired network adapter, a wireless network adapter, and/or a mobile telecommunications adapter. Equipment control interface 140 is coupled in communication with one or more control devices (shown in FIG. 2). Equipment control interface 140 receives information from and/or transmits instructions to the control devices. A control device may include, without limitation, a switch, a motor, a solenoid, a servomechanism, a sensor (e.g., a voltage sensor or a temperature sensor), and/or any other device suitable for operating and/or monitoring utility equipment.

In an exemplary embodiment, computing device 105 stores in memory device 110 and/or is operable to access via communication interface 135 (e.g., from another computing device 105) data for use in operating a utility system. For example, such data may include, but is not limited to only including, configuration data (e.g., a target utility output), utility equipment data (e.g., an operating condition of a utility substation, a utility meter, a utility transmission line, and/or any other utility equipment), and/or partition data (e.g., data describing neighboring partitions that are capable of providing the utility).

FIG. 2 is block diagram of an exemplary system 200 that includes a first partition 202, a second partition 204, and a third partition 206. First partition 202 includes a first utility substation 208 monitored and controlled by a first partition controller 210. Second partition 204 includes a second utility substation 212 monitored and controlled by a second partition controller 214. Third partition 206 includes a utility generation facility 216 monitored and controlled by a third partition controller 218. Further, each partition 202, 204, 206 may include any quantity of utility substations 208, 212 and/or generation facilities 216, each of which is monitored and controlled by a corresponding partition controller 210, 214, 218.

First partition controller 210, second partition controller 214, and third partition controller 218 are computing devices 105 (shown in FIG. 1). While certain operations are described below with respect to particular computing devices 105, it is contemplated that any computing device 105 may perform any of the described operations.

In exemplary embodiments, first partition controller 210, second partition controller 214, and third partition controller 218 are positioned remote to each other and are coupled in communication by a network 220 via communication interfaces 135 (shown in FIG. 1). Network 220 may include, without limitation, the Internet, a local area network (LAN), a wide area network (WAN), a wireless LAN (WLAN), a mesh network, and/or a virtual private network (VPN).

In some embodiments, partitions may be selectively coupled to each other. In the exemplary embodiment, first partition 202 is selectively coupled to second partition 204 by a first utility connection 222, and to third partition 206 by a second utility connection 224. Second partition 204 is selectively coupled to third partition 206 by a third utility connection 226. Operation of first utility connection 222 is controlled by one or more control devices, such as a first switch 230 and a second switch 232. In addition, or alternatively, a control device may include, without limitation, a valve, a transformer, and/or any other device operable to control the conveyance of a utility via a utility connection.

In the exemplary embodiment, electricity is conveyed from first partition 202 to second partition 204, and/or from second partition 204 to first partition 202, when both first switch 230 and second switch 232 are closed. First switch 230 is operatively coupled to first partition controller 210, and second switch 232 is operatively coupled to second partition controller 214 (e.g., via equipment control interfaces 140, shown in FIG. 1). Accordingly, in the exemplary embodiment, both first partition controller 210 and second partition controller 214 control whether electricity is conveyed by first utility connection 222.

Further, in the exemplary embodiment, operation of second utility connection 224 is controlled by a third switch 234, which is operatively coupled to first partition controller 210. Operation of third utility connection 226 is controlled by a fourth switch 236, which is operatively coupled to second partition controller 214. Accordingly, in the exemplary embodiment, first partition controller 210 controls whether electricity is conveyed by second utility connection 224, and second partition controller 214 controls whether electricity is conveyed by third utility connection 226.

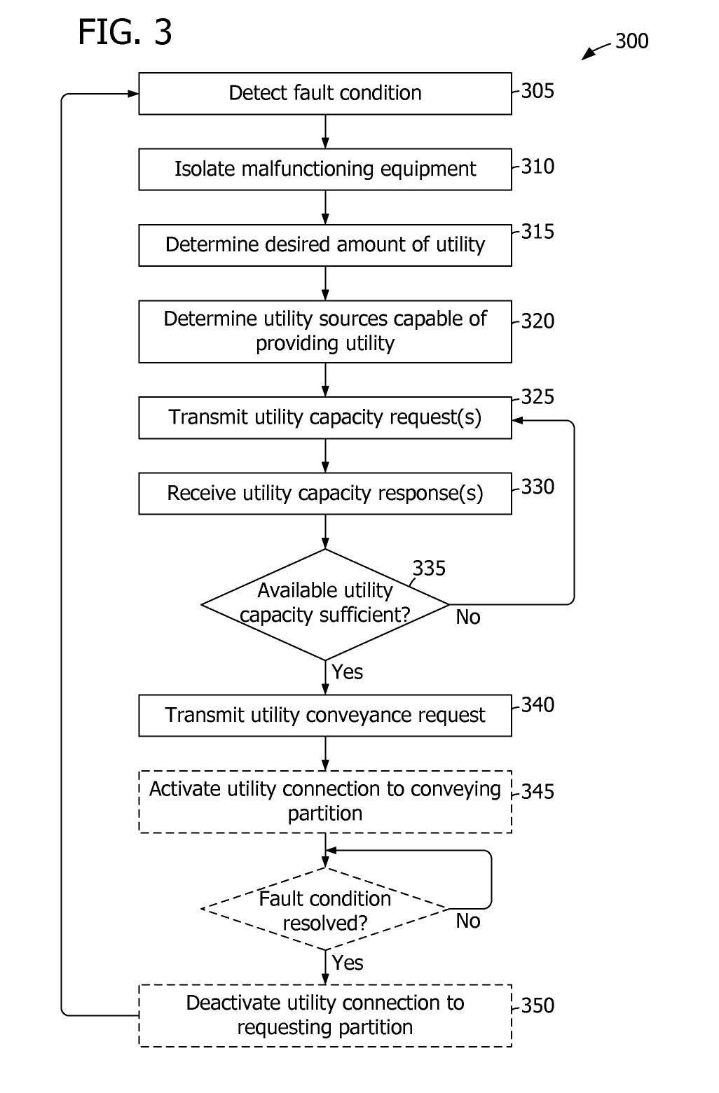

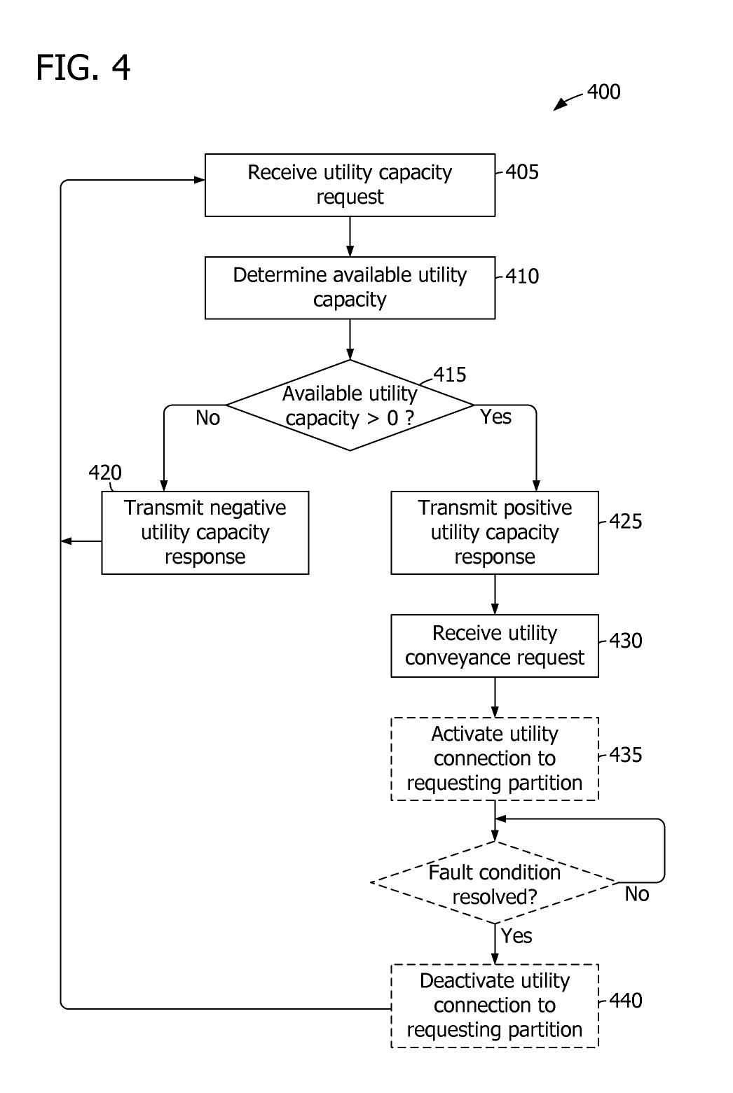

FIG. 3 is a flowchart of an exemplary method 300 for use in requesting and receiving assistance from another partition that may be used with utility system 200. FIG. 4 is a flowchart of an exemplary method 400 that may be used in responding to a request for assistance from another partition that may be used with utility system 200. In exemplary embodiments, as described in more detail below, partition controllers exchange requests and responses indicating desired amounts of the utility and available utility capacities. A utility connection between a requesting partition and one or more conveying partitions may be activated based on the available utility capacities.

Referring to FIGS. 2 and 3, in exemplary embodiments, a computing device 105 (shown in FIG. 1), such as first partition controller 210, detects 305 a fault condition. For example, equipment control interface 140 (shown in FIG. 1) of first partition controller 210 may monitor utility equipment in first substation 208 and detect 305 a fault condition when the utility equipment malfunctions, when the utility equipment transmits a fault notification, and/or when the utility equipment does not respond to a message from first partition controller 210.

The fault condition is associated with a decrease in utility output at first partition 202. For example, if utility system 200 conveys electricity, the fault condition may represent a malfunction of a transformer in first substation 208, and the output of first partition 202 may be diminished by the amount of electrical power (e.g., expressed in watts, kilowatts, or megawatts) that was provided by the transformer before the malfunction.

In some embodiments, first partition controller 210 isolates 310 the malfunctioning equipment from other utility equipment in first substation 208. For example, first partition controller 210 may be configured to open switches (not shown) within first substation 208 that connect the malfunctioning equipment to properly functioning utility equipment.

First partition controller 210 determines 315 a desired amount of the utility based on the decrease in utility output. For example, if first partition controller 210 is configured to attempt to achieve a full recovery of utility output, the desired amount of the utility may be equal to the decrease in utility output. If first partition controller 210 is configured to attempt to achieve a partial recovery of utility output, the desired amount of the utility may be less than the decrease in utility output.

First partition controller 210 determines 320 one or more partitions other than first partition 202 that are capable of conveying the utility to first partition 202. For example, first partition controller 210 may determine 320 such other partitions by identifying partitions that are couplable to first partition 202 by a utility connection. In some embodiments, such partition data and/or utility connection data is stored at first partition controller 210 (e.g., in memory device 110, shown in FIG. 1). In the exemplary embodiment, first partition controller 210 determines 320 that first partition 202 is couplable to second partition 204 by first utility connection 222 and that first partition 202 is couplable to third partition 206 by second utility connection 224.

First partition controller 210 transmits 325, such as by using communication interface 135 (shown in FIG. 1), a utility capacity request to one or more of the partitions determined 320 to be capable of conveying the utility. In exemplary embodiments, the utility capacity request indicates and/or includes the desired amount of the utility.

Referring to FIGS. 2 and 4, second partition controller 214 and third partition controller 218 each receive 405 the utility capacity request. Second partition controller 214 determines 410 an available utility capacity of second partition 204, and third partition controller 218 determines 410 an available utility capacity of third partition 206. In exemplary embodiments, second partition controller 214 determines 410 the available capacity of second partition 204 at least in part by determining the amount of the utility that second utility substations 212 are capable of providing in excess of the demand placed on, or predicted to be placed on, second utility substations 212 by one or more demand points 240, such as residential, commercial, and/or industrial properties. Similarly, third partition controller 218 may determine 410 the available capacity of third partition 206 at least in part by determining the amount of the utility that generation facilities 216 are capable of providing in excess of the demand placed on, or predicted to be placed on, generation facilities 216 by second partition 204 (e.g., including second utility substations 212) and/or any other partitions and demand points to which third partition provides the utility.

Second partition controller 214 and third partition controller 218 each determine 415 whether the available utility capacity of the corresponding partition is greater than zero or, alternatively, whether the available utility capacity is greater than zero by a predetermined threshold value (e.g., 50 kilowatts, 100 kilowatts, or 500 kilowatts). If not, the partition controller transmits 420 a utility capacity response indicating that the corresponding partition has no available utility capacity. Otherwise, the partition controller transmits 425 a utility capacity response that indicates the available utility capacity of the corresponding partition. A utility capacity response indicating that a partition has no available capacity may be referred to as a negative utility capacity response, whereas a utility capacity response indicating that a partition does have available capacity may be referred to as a positive utility capacity response.

Referring to FIGS. 2-4, in exemplary embodiments, second partition controller 214 and third partition controller 218 transmit 420, 425 utility capacity responses to first partition controller 210. First partition controller 210 receives 330 the utility capacity responses and determines 335 whether the available utility capacity indicated by the utility capacity responses is sufficient to achieve a recovery of utility output at first partition 202.

In exemplary embodiments, first partition controller 210 determines 335 whether any single utility capacity response indicates an available utility capacity that is greater than or equal to the desired amount of the utility that was previously determined 315. If so, first partition controller 210 transmits 340 a utility conveyance request to the partition controller that sent the utility capacity response. The utility conveyance request indicates that first partition controller 210 intends to activate a utility connection between first partition 202 and the partition associated with the partition controller to which the request is transmitted 340.

If first partition controller 210 receives 330 a plurality of utility capacity responses indicating an available utility capacity greater than or equal to the desired amount of the utility, first partition controller 210 may select the partition associated with the greatest available utility capacity and transmit 340 a utility conveyance request to the partition controller associated with the selected partition.

In some embodiments, if no single utility capacity response indicates an available utility capacity that is greater than or equal to the desired amount of the utility, first partition controller 210 determines 335 whether the sum of two or more available utility capacities is greater than or equal to the desired amount of the utility. For example, first partition controller 210 may select second partition 204 and third partition 206 based on determining 335 that the combined available capacity of second partition 204 and third partition 206 is greater than the desired amount of the utility. In such an example, first partition controller 210 transmits 340 a utility conveyance request to each of second partition 204 and third partition 206.

Some embodiments facilitate achieving a partial recovery of utility output when a full recovery is infeasible or impossible. In some such embodiments, if the sum of available utility capacities is less than the desired amount of the utility but greater than or equal to a predetermined threshold value that is greater than or equal to zero, first partition controller 210 considers the total available utility capacity sufficient. First partition controller 210 selects one or more partitions associated with the greatest available utility capacities and transmits 340 a utility conveyance request to the partition controller associated with each selected partition.

When the sum of available utility capacities is less than the predetermined threshold value, first partition controller 210 continues by repeatedly (e.g., periodically or continuously) transmitting 325 utility capacity requests, receiving 330 utility capacity responses, and determining 335 whether the indicated available utility capacities are sufficient, as described above. Further, in some embodiments, when first partition controller 210 achieves a partial recovery of utility output, first partition controller 210 repeatedly transmits 325 utility capacity requests, receives 330 utility capacity responses, and determines 335 whether the indicated available utility capacities are sufficient. Such embodiments facilitate detecting an increase in available utility capacity in another partition and conveying the newly available capacity to first partition 202.

In the exemplary embodiment, second partition controller 214 and third partition controller 218 receive 430 the utility conveyance requests. Second partition controller 214 and third partition controller 218 may respond to the utility conveyance requests based on the configuration of equipment within utility system 200. For example, second partition 204 is couplable to first partition 202 by first utility connection 222, which is operable only when both first switch 230 and second switch 232 are closed. Accordingly, in response to receiving 430 a utility conveyance request from first partition controller 210, second partition controller 214 may activate 435 first utility connection 222 in part by closing second switch 232. Similarly, first partition controller 210 may activate 345 first utility connection 222 in part by closing first switch 230. While first utility connection 222 is activated, the utility is conveyed from second substations 212 to first substations 208.

In the exemplary embodiment, third partition 206 is couplable to first partition 202 by second utility connection 224, which is operable only when third switch 234 is closed. Accordingly, first partition controller 210 may activate 345 second utility connection 224 by closing third switch 234. Because first partition controller 210 operates the only switch (i.e., third switch 234) controlling second utility connection 224, third partition controller 218 may not operate any equipment in response to receiving 430 a utility conveyance request from first partition controller 210. While second utility connection 224 is activated, the utility is conveyed from generation facilities 216 to first substations 208. In exemplary embodiments, if second partition controller 214 or third partition controller 218 receives 405 a utility capacity request (e.g., from a fourth partition controller, not shown) while the corresponding partition is conveying the utility to first partition 202, the amount of the utility being conveyed to first partition 202 is reflected in the available utility capacity reported to the requesting partition controller. For example, if second utility substations 212 are conveying one megawatt of electrical power to first substations 208, second partition controller 214 may determine 410 that the available utility capacity of second partition is one megawatt less than previously determined 410 when responding to the utility capacity request from first partition controller 210.

When the fault condition detected 305 by first partition controller 210 is resolved, first partition controller 210 may deactivate 350 any activated utility connections between first partition 202 and other partitions, such as first utility connection 222 and second utility connection 224. For example, first partition controller 210 may open first switch 230 to deactivate 350 first utility connection 222. In addition, or alternative to, first partition controller 210 may transmit a deactivation request to second partition controller 214, and, in response to the deactivation request, second partition controller 214 may deactivate 440 first utility connection 222 by opening second switch 232. First partition controller 210 may deactivate 350 second utility connection 224 by opening third switch 234.

In exemplary embodiments, first partition controller 210, second partition controller 214, and third partition controller 218 each repeatedly (e.g., periodically and/or continuously) execute method 300 and method 400. Such embodiments facilitate automatically responding to fault conditions within any portion of utility system 200. For example, a decrease in utility output associated with a fault condition within any partition may be determined, and a full or partial recovery of the utility output may be achieved by determining the available utility capacity of one or more neighboring partitions and activating a utility connection between the affected partition and one or more such neighboring partitions to compensate for the decrease in utility output. Embodiments described herein further enable utility system 200 to automatically respond to a resolution of such a fault condition by deactivating utility connections between partitions that are no longer needed. Accordingly, the delay and the risk of error associated with manually responding to fault conditions may be reduced and/or eliminated.

Embodiments described herein may be performed using a computer-based or computing-device-based operating environment as described below. A computer or computing device may include one or more processors or processing units, system memory, and some form of non-transitory computer-readable media. Exemplary non-transitory computer-readable media include flash memory drives, hard disk drives, digital versatile discs (DVDs), compact discs (CDs), floppy disks, and tape cassettes. By way of example and not limitation, computer-readable media comprise computer storage media and communication media. Computer-readable storage media are non-transitory and store information such as computer-readable instructions, data structures, program modules, or other data. Communication media typically embody computer-readable instructions, data structures, program modules, or other data in a modulated data signal such as a carrier wave or other transport mechanism and include any information delivery media. Combinations of any of the above are also included within the scope of computer-readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other apparatus and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention may be practiced with modification within the spirit and scope of the claims.

What is claimed is:

1. A system for use in operating a utility system that provides a utility, said system comprising a first partition controller, the first partition controller comprising:
an equipment control interface configured to detect a fault condition at a first partition of the utility system;
a processor coupled to said equipment control interface and programmed to:
determine a desired amount of the utility based on a decrease in utility output associated with the fault condition; and
determine a plurality of partitions other than the first partition that are capable of conveying the utility to the first partition; and
a communication interface coupled to said processor and configured to transmit a utility capacity request to a plurality of remote partition controllers, wherein each remote partition controller is associated with a partition of the plurality of partitions, and the utility capacity request indicates the desired amount of the utility.

2. A system according to claim 1, wherein said communication interface is further configured to receive a response from a second partition controller of the plurality of remote partition controllers, wherein the response indicates an ability of a second partition to convey the desired amount of the utility, and said equipment control interface is further configured to activate a utility connection between the first partition and the second partition when the second partition is able to convey the desired amount of the utility.

3. A system according to claim 2, wherein said equipment control interface is further configured to:
detect a resolution of the fault condition; and
in response to the resolution, deactivate the utility connection between the first partition and the second partition.

4. A system according to claim 1, wherein said equipment control interface is further configured to:
detect malfunctioning equipment associated with the fault condition; and
isolate the malfunctioning equipment from other equipment in the first partition.

5. A system according to claim 1, wherein said communication interface is further configured to receive from each remote partition controller of the plurality of remote partition controllers a utility capacity response indicating an available utility capacity of an associated partition, and said processor is further programmed to select a second partition and a third partition from the plurality of partitions based on the indicated available utility capacities.

6. A system according to claim 5, wherein a second partition controller associated with the second partition indicates a first available utility capacity, a third partition controller associated with the third partition indicates a second available utility capacity, and said processor is further programmed to select the second and third partitions based on determining that a sum of the first available utility capacity and the second available utility capacity is greater than or equal to the desired amount of the utility.

7. A system according to claim 5, wherein said equipment control interface is further configured to:
activate a first utility connection between the first partition and the second partition; and
activate a second utility connection between the first partition and the third partition.

8. A method for use in operating a utility system that includes a first partition and a second partition, said method comprising:
detecting, by a first partition controller associated with the first partition, a fault condition within the first partition;
transmitting, by the first partition controller, a utility capacity request to one or more partition controllers other than the first partition controller;
receiving, by a second partition controller associated with the second partition, the utility capacity request;
determining, by the second partition controller, an available utility capacity of the second partition; and
transmitting, by the second partition controller, a utility capacity response that includes the available utility capacity of the second partition to the first partition controller, wherein a utility connection is activated between the first partition and the second partition based on the available utility capacity.

9. A method according to claim 8, further comprising activating the utility connection by the first partition controller.

10. A method according to claim 8, further comprising:
transmitting, by the first partition controller, a utility conveyance request to the second partition controller; and
in response to the utility conveyance request, activating the utility connection by the second partition controller.

11. A method according to claim 8, further comprising determining, by the first partition controller, a desired amount of the utility associated with the first partition, wherein the utility connection is activated when the available utility capacity of the second partition is greater than or equal to the desired amount of the utility.

12. A method according to claim 8, wherein the utility system further includes a third partition, said method further comprising:
receiving, by a third partition controller associated with a third partition, the utility capacity request; and
transmitting, by the third partition controller, a utility capacity response that includes an available utility capacity of the third partition to the first partition controller.

13. A method according to claim 12, further comprising:
determining, by the first partition controller, that the available utility capacity of the second partition and the available utility capacity of the third partition are less than the desired amount of the utility; and
activating, by the first partition controller, a first utility connection between the first partition and the second partition and a second utility connection between the first partition and the third partition when a sum of the available utility capacity of the second partition and the available utility capacity of the third partition is greater than or equal to the desired amount of the utility.

14. A method according to claim 12, further comprising:
determining, by the first partition controller, that a sum of the available utility capacity of the second partition and the available utility capacity of the third partition is less than the desired amount of the utility; and
activating, by the first partition controller, a first utility connection between the first partition and the second partition and a second utility connection between the first partition and the third partition when the sum is greater than or equal to a predetermined threshold value.

15. A method according to claim 8, further comprising
detecting, by the first partition controller, malfunctioning equipment associated with the fault condition; and
isolating, by the first partition controller, the malfunctioning equipment from other equipment in the first partition.

16. A method according to claim 8, further comprising detecting, by the first partition controller, a resolution of the fault condition, wherein the utility connection is deactivated in response to the resolution.

17. One or more non-transitory computer-readable storage media having computer-executable instructions embodied thereon, wherein when executed by at least one processor, the computer-executable instructions cause the at least one processor to:
detect a fault condition associated with a decrease in utility output at a first partition of a utility system;
determine a desired amount of the utility based on the decrease in utility output;
receive an available utility capacity from a partition controller that is associated with a second partition of the utility system; and
activate a utility connection between the first partition and the second partition based on the available utility capacity.

18. One or more storage media according to claim 17, wherein the computer-executable instructions further cause the processor to activate the utility connection when the available utility capacity is greater than or equal to the desired amount of the utility.

19. One or more storage media according to claim 17, wherein the computer-executable instructions further cause the processor to transmit a utility capacity request to the second partition controller, wherein the utility capacity request indicates the desired amount of the utility.

20. One or more storage media according to claim 17, wherein the second partition is included in a plurality of remote partitions that are capable of providing a utility to the first partition, and the computer-executable instructions further cause the processor to:
receive a plurality of available utility capacities, wherein each available utility capacity is associated with a remote partition of the plurality of remote partitions; and
activate the utility connection between the first partition and the second partition when the available utility capacity associated with the second partition is greater than the available utility capacities associated with the remote partitions other than the second partition.
